(19) United States
(12) Patent Application Publication
(10) Pub. No.: US 2007/0027850 A1
(43) Pub. Date: Feb. 1, 2007

(54) Methods and systems for developing and managing a computer-based marketing campaign

(75) Inventors: John Chan, New York, NY (US); Prashant Desai, New York, NY (US); Peter Hershberg, New York, NY (US); Vince Russo, Shrewsbury, MA (US); Randy Schwartz, New York, NY (US); Joshua Stylman, Brooklyn, NY (US); Joel Lapp, New York, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Reprise Media, LLC

(21) Appl. No.: 11/194,381

(22) Filed: Aug. 1, 2005

(51) Int. Cl. G06F 17/30

(52) U.S. Cl. 707/3

(57) ABSTRACT

A method and system for creating a production sheet for a media venue are disclosed. Content pertaining to one or more of a product and a service may be received. One or more assets may be automatically generated based on the content. The assets may include, for example, a keyword and a creative. A creative may be advertising copy and may include placeholders for information pertaining to the keyword. Pricing information may be accessed from a database. The pricing information may be related to the keyword. A bid price may be determined for the keyword based on the pricing information. A production sheet may then be generated. The production sheet may include the keyword and the creative, and may delimit the terms of an advertising and/or marketing campaign. The production sheet may then be submitted to a media venue.

### TECHNICAL FIELD

The disclosed embodiments generally relate to the field of computer-based marketing. More particularly, the disclosed embodiments relate to methods and systems for automatically developing advertising and/or marketing campaigns for media venues via data extraction.

### BACKGROUND

Traditional advertising is displayed in many forums, including newspapers, magazines and other print media; television, radio, and other broadcast media; and billboards and other signs. With the advent of the Internet, computer-based media such as Web sites are now used to display advertising as well. Banner advertisements, pop-ups, pop-unders, text links, buttons and the like can all be used to advertise over a computer network. In particular, Web sites providing search services, such as search engines, directory listings, and the like, offer advertisers significant reach into the Internet audience and provide the opportunity for targeted advertising to interested consumers. Exemplary search engines include Google®, AltaVista®, Ask.com, and the like. Exemplary directory listing Web sites include Yahoo.com.

Search engines or topical search requests return a listing of Web page links based on, for example, one or more keywords. Typically, two types of resultant listings are displayed: algorithmic results and paid listings. Algorithmic results are determined by a particular engine using a methodology for indexing website listings against a user search query, based on the relevancy of the listings as perceived by the algorithm. Paid listings are commonly labeled for the user as “sponsored listings.” Advertisers can influence the order of the resultant paid listings by purchasing a prominent place in the listings. This is usually performed by placing a sufficiently high bid with the media venue. For Web sites implementing paid listings, the advertisers usually pay the media venue owner for each click-through referral that is received from an accessing user. The advertiser offering the most money per click typically occupies the first position in such listings. The advertiser offering the second most occupies the second position, and so on. In some cases, paid listings are ranked by a combination of advertiser bids and the click-through rates for such listings. Higher positions in any such listing have been exhibited to result in higher click-through rates and inevitably influence an advertiser's ability to harvest click-transfers from those competitive search result listings. Thus, advertisers have an incentive to select and bid on the search keywords that are most relevant to their Web site offerings. Such search engines or topical listings are termed “pay-per-click” or “pay-for-placement” advertisements.

Particular marketing assets are typically required to create and coordinate the launch of an online marketing or advertising campaign. In general, text-based assets are compiled into a production sheet for submission to media venues such as search engines, directory listings or online publishers. Editorial departments for the advertisers generally approve these assets prior to submission. Although each media venue requires a different production sheet with different specifications, a basic set of fields is typically designated for each media venue. Such fields include keywords or phrases (i.e., search terms for which an advertiser would like to feature an advertisement), creatives (i.e., advertising copy served in connection with each purchased keyword), landing pages (i.e., the Web page upon which a user lands when the advertisement is selected), keyword categories (i.e., the manner in which keywords are grouped together within a production sheet), match-type assignment rules (i.e., the rules by which an advertisement is featured on a search engine's results page), and an entry bid or maximum cost per click (CPC) (i.e., the amount of money an advertiser is willing to pay for each click on an advertisement).

Various products have been developed to assist with the assembly of content for a production sheet. For example, Quigo, Inc. has developed a product that crawls and extracts product information from static Web content. Chitika, Inc. and Entrieva, Inc. have created taxonomy classifiers to provide structure to unorganized content using word frequency, co-occurrence, co-relevancy and proximity measures. International Business Machines Corporation has developed a deep-Web extraction program for retrieving data from a forms-based Web site. Other companies, such as Ask Jeeves, Inc. and Vivisimo, Inc., have developed categorizers that organize textual information into hierarchical folders. All of these products may be used to assist in the construction of networks using semantic taxonomies. Publishers may leverage content in these existing frameworks to monetize their content and match the content to opportunities for paid advertisements.

However, none of the above listed products leverages and organizes content feeds to create advertisement and/or marketing campaign assets. What is needed is a method and system for extracting and organizing content to generate advertising and/or marketing campaign assets from real-time and near real-time content feeds for submission to media venues.

A need exists for a method and system for automatically generating production sheets based on the extracted content.

A further need exists for a method and system for determining appropriate initial and/or maximum bids for submission to a media venue.

The present disclosure is directed to solving one or more of the above-listed problems.

### SUMMARY

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “keyword” is a reference to one or more keywords and equivalents thereof known to those skilled in the art, including search phrases, associated directory entries and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

The disclosed embodiments define a process that minimizes the time (and manual effort) required to create marketing campaigns for media venues. A media venue may include a search engine, a directory listing, an Internet publication, a network of Internet sites, or any other Internet Web site or portion of an Internet Web site. In addition, a media venue may include any other outlet for an advertising or marketing campaign, such as broadcast media, including a media player, a WiFi network, and/or interactive television; print media, such as a print publication, a classified listing, a newspaper, a public computer terminal, a kiosk, a direct mailing, and a telephone directory; and/or the like. Assets may be extracted, created and/or assembled in real-time or near real-time by, for example, bypassing the Web site structure and accessing the content publishing system. As such, recent updates to an advertiser Web site may be automatically incorporated into an advertisement without the delay of manual processing.

Moreover, the process may determine a minimum price to bid for particular keywords for advertisements in particular media venue based upon data received, for example, from each media venue at which the advertisement is placed. In particular, because the advertising content and search terms are provided to the Web site in a real-time or near real-time fashion in advance of competing advertisements, the competitive forces that inflate bid prices may be avoided. As such, CPC advertisements may be launched at entry bid prices, which may represent the difference between, for example, a $0.05 bid and a $2.55 bid for the same position in a resultant listing and may yield the same or a similar volume of clicks.

In an embodiment, a method for creating a production sheet for a media venue may include receiving content pertaining to one or more of a product and a service, automatically generating one or more assets, including a keyword and a creative, based on the content, generating a production sheet including the keyword and the creative, and submitting the production sheet to a media venue.

In an embodiment, a system for creating a production sheet for a media venue may include a processor, a processor-readable storage medium in communication with the processor, a communication network in communication with the processor, and a media venue server in communication with the communication network. The processor-readable storage medium may contain one or more programming instructions for performing a method for creating a production sheet for a media venue. The method may include receiving content pertaining to one or more of a product and a service, automatically generating one or more assets, including a keyword and a creative, based on the content, generating a production sheet including the keyword and the creative, and submitting the production sheet to the media venue server via the communication network.

### BRIEF DESCRIPTION OF THE DRAWINGS

Aspects, features, benefits and advantages of the embodiments described herein will be apparent with regard to the following description, appended claims and accompanying drawings where:

FIG. 1 depicts a high-level flow diagram for implementing a content extraction and campaign creation process according to an embodiment.

FIG. 2A depicts a flow chart for structured data extraction, synthesis and campaign creation according to an embodiment.

FIG. 2B depicts a flow chart for unstructured data extraction, synthesis and campaign creation according to an embodiment.

FIG. 3 is a block diagram of exemplary internal hardware that may be used to contain or implement program instructions according to an embodiment.

### DETAILED DESCRIPTION

The disclosed embodiments may generally pertain to data mining and assembly of content for procuring finished production assets required by, for example, a media venue for the purpose of creating, for example, an advertising and/or marketing campaign.

An asset may include text, graphics, sound, and/or any other information pertaining to an advertising and/or marketing campaign or included in a production sheet. Assets may include, without limitation, a keyword or search phrase, a creative, a bid price, a file locator, such as a Uniform Resource Locator (URL) or a file Transfer Protocol (FTP) locator, a keyword category, a rule used to determine when to display the creative on the media venue (or how to display the creative), a campaign title, a product description, a graphic image, a sound file, and/or a video clip. A keyword may include one or more search terms, one or more search term queries, one or more directory pages, one or more advertisement network categories, one or more sub-channels and/or the like. A creative may include one or more text messages written to a media venue's specifications and/or attributes of a broader brand strategy including text, a slogan, a jingle, a video clip, a sound clip, an image and/or the like. In an embodiment, an additional asset, a tracking identifier (TID), may be assigned to each unique combination of the aforementioned assets. A TID may be used to associate the amount of money spent on a combination of assets with the client revenue or backend activity generated by the combination.

In particular, the disclosed embodiments may crawl through structured and/or unstructured content to provide structure according to one or more defined rule sets. Disclosed embodiments may receive structured or unstructured content and convert the content to be deployed on one or more media venues for advertising and/or marketing campaigns.

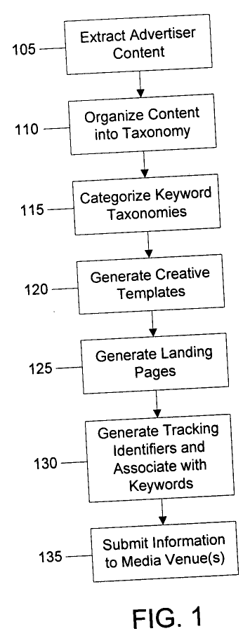

FIG. 1 depicts a high-level flow diagram for implementing a content extraction and campaign creation process according to an embodiment. As shown in FIG. 1, content may initially be accessed and extracted 105 from an advertiser's Web site or another source as described below. Content extraction may be performed in a plurality of ways, including push and pull model extraction methods described below. The content may be used, for example, to develop an advertising campaign. Such a campaign may provide comprehensive listings in response to a plurality of customer queries that pertain to content on an advertiser's Web site.

Production assets, such as keywords or phrases, creatives, landing pages, keyword categories, match-type assignment rules, and bid information, may be extracted from the advertiser's content publishing system or may otherwise result from processing assets. In an embodiment, a content management system, such as the systems designed by Vignette Corp. or Blue Martini Software, Inc., may provide the content directly. Such systems may provide content without formatting, organization or presentation artifacts within a Web site or database. Alternately, content may be extracted from structured and/or unstructured data sources in either a push model or a pull model.

Push model extraction may occur when an advertiser sends information to a data extraction location. Alternately, the advertiser may extract information using its own system. In an embodiment, push model extraction may be performed using a feed-based system. In such a system, feed-based content may be provided and pushed through a campaign development interface using, for example, a Resource Description Framework Site Summary (RSS) file format, an Extensible Markup Language (XML) file format, or any file format that easily and accessibly propagates content (encoded content, text, etc.).

In an alternate embodiment, push model extraction may be performed when an advertiser places information at an accessible Internet Protocol (IP) location from which content is extracted using the File Transfer Protocol (FTP). The content may be extracted from the IP location periodically, such as hourly, daily or the like.

In an embodiment, an Application Programming Interface (API) may be used to accept, collect and/or extract content from known locations on a periodic or non-periodic basis. An API may be a programming interface that enables disparate, mutually exclusive computer hardware and/or software systems or infrastructures to converse with each other and allow information to pass from one structure to another without human interaction. The information may be normalized to a mutual form. In an embodiment, an API may be implemented by systems built on different platforms, infrastructures encoded by different programming languages, or other system parameters. In such an embodiment, the API may be devised based on a format used to receive data and assets from a particular source, which are converted to campaign production assets. In an embodiment, the API may be an interface with a plurality of destination sites, advertising networks, engines, products, and/or the like.

In an embodiment, pull model extraction may be performed using a crawling technique. Information and/or assets may be accessed and extracted from, for example, an advertiser's intranet, an advertiser's extranet, deep-Web extraction, and/or hidden Web content. An intranet may be a computer network internal to the advertiser's operations which contains information pertaining to all facets of the advertiser's business.

An extranet may include, for example, publicly available information regarding the advertiser, its products and/or its services. The extranet may further include message boards, chat rooms, newsgroups and/or blogs containing information or discussions pertaining to the advertiser, its products and/or its services. Such information may be particularly relevant in determining topics that are currently of interest to consumers of the advertiser's products and/or services. In addition, the topics may become the advertiser's product or service. For example, the content from such discussions and the user profiles of those participating in discussions may be used to create meta-data that is leveraged for targeted advertising selections and/or harvested for market research and/or customer intelligence.

Deep-Web extraction may include accessing corporate, financial, human resource records, sales force records and the like to extract pertinent information relating to the advertiser, its products and/or its services. Document types may include PDFs, Microsoft Word® documents, Microsoft Outlook® files, Flash files, rich media, photos, video and music files, and the like. Graphic content may be crawled, for example, by using image mapping or scanning meta-data.

Hidden Web content may include content embedded within forms-based interfaces. In an embodiment, search queries may be generated for such interfaces to access hidden fields and disclose hidden content. As such, an index of response forms may be generated to access the hidden Web content.

The extraction process may be applied to any media venue that indexes comparative advertisement listings. For example, the process may be performed for a plurality of advertisement models that require similar production assets. Such advertising models may include, without limitation, CPC, cost per impression (CPM), cost per conversion (CPA) and flat rate models. In addition, the process may be applied to traditional search technologies, such as Google® and Yahoo!®; emerging search engines, such as MSN® Search; and/or vertical-based engines and marketplaces. In this manner, the disclosed embodiments may additionally accommodate customer campaigns, business-to-business markets, shopping, travel engines, classified listing sites, channel-based contextual advertisement networks and the like.

The content may then be organized 110 into a taxonomy of keywords and/or search phrases. A taxonomy may be generated by organizing terms semantically based on frequency, proximity to other terms, and/or proximity to other critical keywords and concepts. The taxonomy may be used to devise a list of viable keyword concepts and search phrases and/or suggest paths of future development. Such keywords and phrases may be compared with synonyms and/or concatenated with particular verbiage, such as geographic terms, action items, descriptors or brand qualifiers, to more specifically enumerate the list of keywords and search phrases for specific content. For example, a basic keyword, such as “ISP,” may be concatenated with descriptors, such as “Verizon,” “reliable,” and/or “in Boston.” As such, root search terms may be expanded into more specific and evocative variations to provide more directed content to consumers entering a particular query. Such variations may enable an engine to provide greater utility to its audience through far more specific call-response matching.

In an embodiment, a taxonomy may be built from a database of keywords from prior campaigns performed by the advertiser and/or other advertisers and applied to prioritize verbiage and semantic relationships that have previously received particular levels of customer response. In this manner, root terms may be concatenated with the most practical verbiage that consumers actually use to search and convert into clicks and/or acquisitions.

The taxonomy of keywords and search phrases may then be refined 115 based on previously created taxonomies unique to past campaign experience or on new keyword development taxonomies. Categorization of the taxonomy may provide particular benefits. For example, thematically grouped keywords may allow creative templates to be more easily customized by inserting a specific keyword into an otherwise appropriate title or description. Moreover, such categorization (also known as “bucketing”) may provide statistical support for building representative data samplings for each campaign sub-part, which is currently performed manually by marketing managers. Instead, keywords and/or search phrases may be pooled together to suggest the types of optimizations and refinements that lead to campaign growth. This shift away from granularity may make the campaign drivers more accessible, pliable, and interpretable.

Content may be extracted from the advertiser's site, for example, to create 120 creative templates. In an embodiment, creative templates may be customized through dynamic keyword insertion and adapted to various specifications for the destination. Dynamic keyword insertion may provide commands that instruct a media venue to insert a keyword at a particular point in the creative template. For example, Google® has created a coding short-cut within their ad-server so that language surrounding an insertion point may be kept standard before and after dynamic insertion. Thus, a template including, for example, a title entry submitted as “{Keyword:The ChangeOne} Program” may instruct the server to append “Program” to the end of the keyword unless the concatenation of the keyword and “Program” does not meet particular criteria. For example, if the concatenation exceeds a pre-determined length for the field, such as 25 characters, the template may instruct the creative to revert to a title of “The ChangeOne Program.”

In an embodiment, creative templates may be further customized through the addition of product details and/or descriptive elements extracted from content and/or product feeds. These details may be described as “assets” and/or “attributes” within the template.

Landing pages may also be generated 125 by crawling through content. For example, all root terms and keyword assets may be mapped to the pages on which they are contained. Similar terms used in a plurality of pages include URLs and/or destination pages that may be prioritized based upon experiential cues, the hierarchy within a Web site architecture, proximity in the architecture to critical action items and/or as tested within the campaign for optimal backend customer response.

In an embodiment, tracking identifiers may be created and associated 130 with each keyword and/or advertisement element that is operative within each media venue. Tracking identifiers (TIDs) may be used to attribute causal relationships between marketing assets and quantifiable returns. For instance, a TID may be used to determine if a consumer accessed a landing page as a result of a search engine query, and, if so, the particular search engine and/or search query used to access the landing page. The TID may also be used to determine the operations performed by the consumer after reaching the destination.

The taxonomy of keywords and/or search phrases may then be supplied 135 to each of a plurality of media venue inventory forecast tools. An inventory forecast tool may be used to estimate the volume of action-items (impressions, clicks, acquisitions) and/or the proper maximum and/or minimum entry bids based on the particular revenue model for a media venue. For example, an inventory forecast tool may return a CPC entry bid required to secure a top ranked position, such as a top 3 position, in order to obtain “search network syndication.”

Search network syndication may be a process by which distribution of keyword listings is offered across a media venue's partner network. For example, an advertisement placed on Yahoo!® may need to remain in the top 3 placements in order to be syndicated across their network, which may include, for example, yahoo.com and altavista.com. Since CPC bids typically control an advertiser's placement within a search network's search results, bid inflation may result because of search network syndication. For example, an advertiser may be required to pay $0.52 per click to be the fourth rated advertiser, but $1.53 per click to be the third rated advertiser and reach syndication to particular partners. Accordingly, when bids become cost-prohibitive, advertisers may evaluate whether the higher price of syndicated listings is justified by the incremental (but less efficient) volume of clicks for the syndicated advertisement.

The above described process and equivalent processes may be used to create search campaigns and/or contextual campaigns. Moreover, campaigns intended for vertical-based platforms, such as shopping engines, travel, local and/or business directories, and the like, and/or advertisement networks automated with variable bid-management and/or flat rate card monetization may be generated. In an embodiment, the automated process may be designed to extract foreign language assets for international campaign implementations. In an embodiment, the process may swap language assets for language that has been determined to be more effective for particular consumers.

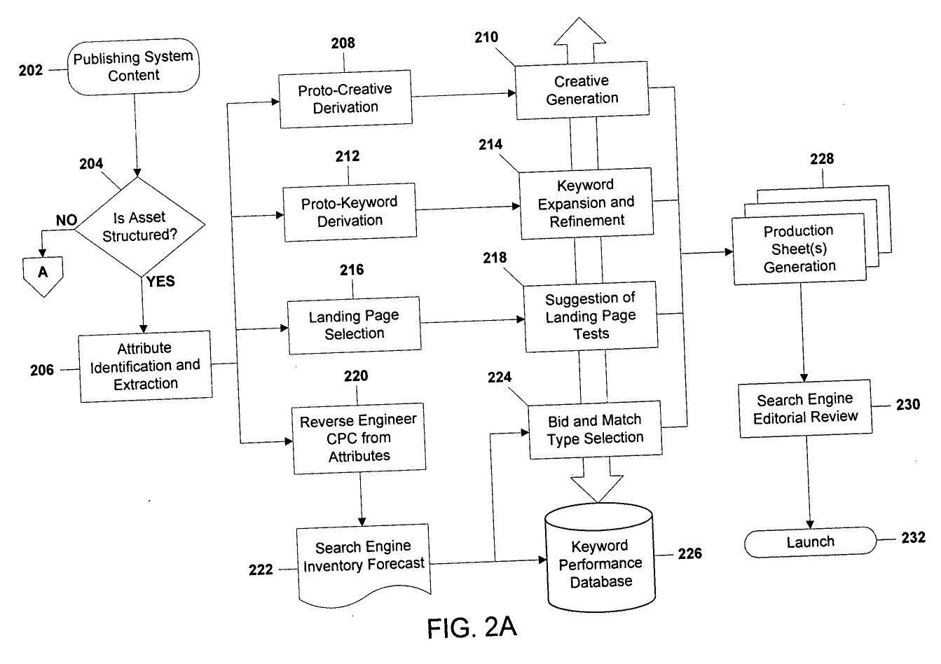

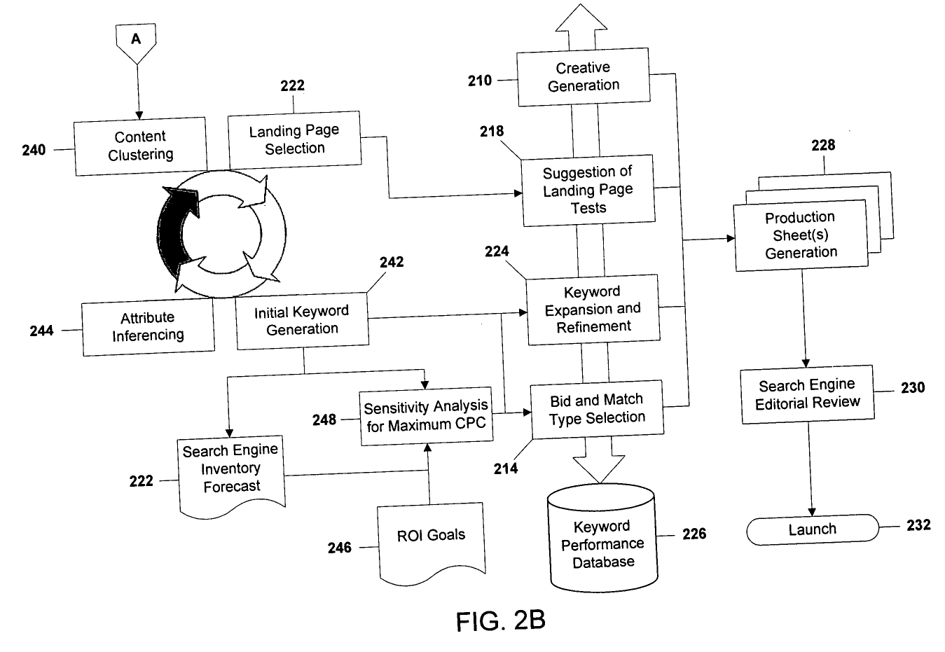

FIG. 2A depicts a flow chart for structured data extraction, synthesis and campaign creation according to an embodiment. As shown in FIG. 2, content may be received or extracted from a publishing system 202. The publishing system may be used to generate content. Campaign assets may be derived from the content generated by the publishing system, which is otherwise accessed through a Web site interface. In an embodiment, accessing the raw data feeds from the publishing system may ease the process of structuring the content. In an alternate embodiment, data may be extracted from a file via a communication network, such as the Internet and/or an intranet.

A determination 204 may be made as to whether the content is structured or unstructured. Structured content may refer to data that is stored in a database or other formatted listing. In an embodiment, database contents for, for example, shopping, travel and classified listings and the like may be formatted as structured data. Structured content may also refer to electronically published, displayed or stored content, such as content in a file describing a Web page or stored within a database where the database associates products with their brands, prices, SKUs, descriptions, etc. Unstructured content may refer to, for example, content from a real-time or near real-time data feed, such as news reports and/or stock quotes, and/or a meta-data string.

If the content is structured, attributes may be identified and extracted 206 from the structured content. In an embodiment, receiving structured data may ease the derivation of creatives 208 and keywords 212 and the selection of landing pages 216 as compared to unstructured data because creatives, keywords and landing pages may be inferred from the data structure.

For example, if a structured data feed includes information pertaining to a particular product for sale, the data feed may be able to derive 208 a creative template from a file location of a graphic image of the product and/or text pertaining to the product that are referenced in the structured listing. The creative elements may then be used to generate 210 a creative for the product and/or service.

Likewise, a keyword may be derived 212 from, for example, a header or title field for a particular entry in a structured content file. In an embodiment, a keyword expansion unit may provide 214 additional keywords based on a vertical market with which the keyword is associated.

Similarly, a landing page may be selected 216 based on a URL or other file locator assigned to a particular content element. Since content elements may be found in various locations of the advertiser's Web site, the advertiser may need to select which Web page best represents the keyword and should be the landing page. The advertiser may test 218 viable landing pages to determine the particular page that most efficiently converts consumers into purchasers.

In an embodiment, CPC bids (or other bid types as appropriate) may be reverse engineered 220 from the attributes. The CPC bids may be determined based on, for example, the expected conversion to sale or registration, the cost of the product and/or service, the margin on the product and/or service, and/or the profit from selling the product and/or service. In an embodiment, the CPC bids may additionally or alternately be determined by accessing an inventory forecast tool 222 for a particular media venue. The bid and match types may then be selected 224 based on the determined CPC bids. A match type may refer to the manner in which a creative is selected based on the keyword associated with the creative. For example, a particular match type may direct the media venue to return the creative in its results if an exact match exists between one or more keywords and a search query. A different match type may direct the media venue to return the creative in its results if the search query includes the one or more keywords.

Each production asset, including the generated creative, the expanded and refined set of keywords, the landing page revisions and the selected bid and match types, may be filtered through the keyword performance database 226 prior to inclusion in a production sheet 228. The database 226 may include information pertaining to previous campaigns within a particular vertical market, and may be used to supplement and/or refine the production assets based on the information pertaining to the vertical market. In an embodiment, previous campaigns may have been generated for the same and/or different advertisers. In an embodiment, the keyword performance database 226 may be maintained by the advertiser and/or a third party representing the advertiser (i.e., a “content maintainer”). In an alternate embodiment, a media venue provider may maintain the keyword performance database 226.

The keyword performance database 226 may include ROI parameters for a plurality of previous campaigns. The parameters in the keyword performance database 226 may be organized based on the media venue from which the parameters are generated. In an embodiment, a media venue may generate a keyword performance database. In this case, the advertiser or its agent may access the media venue's database to retrieve information of interest.

In an embodiment, the database parameters may include click-through totals resulting from particular search queries. Such information may be used to determine whether particular keywords are appropriate or worthwhile for submission to a media venue. For example, if the phrase “white belt” is frequently entered as a search query at a particular media venue, it may be more cost effective for an advertiser to submit a bid for “white belt” instead of “belt” since the bid price for “white belt” will likely be lower than the bid price for “belt.” Additionally, some engines give priority to exact match listings, ranking them higher than those advertiser listings that match the search query by way of broad match. Moreover, since the product description is more precise, a search query for a white belt may be more likely to result in a purchase or click-through than a search query for a general belt (possibly due to the aforementioned dynamic keyword insertion, which creates a stronger connection between the search query and that resultant ad listing). Conversely, if “white belt” is infrequently entered as a search query, a bid may be submitted at the venue's entry bid level, for the rare occasion when it is queried and traffic can be claimed for nominal fees. Alternatively, additional or alternate actions may be taken.

In an embodiment, the database parameters may further include current and/or maximum bid prices for keywords at each media venue. The bid prices and click-through rate for each keyword may be compared with an advertiser's campaign budget information to determine if a particular keyword is appropriate for the campaign. In an embodiment, the budget information may include a duration for the campaign, a total cost for the campaign, a desired number of views, a desired number of click-throughs, a desired number of conversions, and the like. The database parameters may thus be used to qualify the pricing information for a media venue.

Additional parameters in the database may include conversion rates (the percentage of click-throughs that result in consumer sales), click-through rates (the percentage of customer views that result in selection of the landing page), and the like. The database may be used to determine a particular campaign that results in, for example, the maximum return on investment and/or the maximum exposure.

The production assets may then be used to generate 228 one or more production sheets. Each production sheet may pertain to a particular media venue provider or their various products (each segmented by bid market), and may be transmitted to the corresponding media venue provider to initiate an advertising campaign. In an embodiment, a plurality of production sheets may be sent to a single media venue provider to accommodate a plurality of feeds. For example, an advertiser may desire to implement a keyword campaign for e-commerce assets that operates in an open-bid market on a media venue and in a direct pricing feed for submission to a shopping engine on the same media venue. In an embodiment, a production sheet may be provided for each of the open-bid markets and the shopping engine. In an embodiment, a plurality of production sheets may be used to implement sub-campaigns based on keyword categories. Such an embodiment may be used, for example, to prioritize advertisement targets by establishing variable spending caps for each sub-campaign. In this manner, the advertiser may exhibit greater control and efficiency in its campaign spending.

A production sheet 228 may be submitted to a media venue to provide a list of keywords or search phrases for which an advertiser wishes to place a bid. The production sheet may include information such as a keyword, a creative, a bid price, a campaign name, a budget, a keyword category, a maximum CPC, a keyword match type, a file locator to be displayed with the creative, a file locator for a landing page, a TID, a hyperlink to an asset and/or the like.

An exemplary production sheet format is depicted in Table 1.

TABLE 1
Production Sheet

| Ad-Group | Match Type | Keyword(s) | Title | Description | Bid |
|---|---|---|---|---|---|
| Branded | | | Tommy Hilfiger | Classic style w/ | $0.10 |
| | | | watches | quartz movement | |
| | Standard | Tommy Hilfiger | | | $0.10 |
| | Standard | Tommy | | | $0.10 |
| | Standard | Hilfiger | | | $0.10 |
| | Standard | Tommy Hilfinger | | | $0.10 |
| . | . | . | . | . | . |
| . | . | . | . | . | . |
| . | . | . | . | . | . |
| Branded Watch | | | {KeyWord: Tommy | Classic style w/ | $0.10 |
| | | | Hilfiger Watches} | quartz movement | |
| | Broad | Tommy Hilfiger | | | $0.25 |
| | | watch | | | |
| | Broad | Tommy Hilfiger | | | $0.30 |
| | | watches | | | |

A keyword may include a particular word or group of words for which the advertiser desires to direct its advertising or marketing campaign.

A creative may include a particular title, advertisement copy and description of the product and/or service with which a keyword is associated. In an embodiment, a creative may include text describing the product or service, one or more text entry locations if multiple keywords are directed to the same creative, a link to a landing page, a display URL and/or a landing URL. The display URL may be a URL that is displayed to a user as part of a creative. The landing URL may be a URL that is associated with a landing page. In an embodiment, the landing URL may not be displayed as part of the creative. In an embodiment, the display URL and the landing URL for a creative may be the same.

The campaign name may refer to a particular advertising campaign. Each campaign name may pertain to, for example, one or more media venues, its products and/or its services.

A budget may include an expected capital expenditure for a particular unit. For example, a daily budget may be provided for a campaign, a group of related campaigns, a particular media venue, one or more keywords, one or more keyword categories and/or any other grouping of assets and/or attributes.

A keyword category may include a category of related products and/or services. In an embodiment, keywords relating to the same or similar products and/or services may be grouped into a single keyword category. In an embodiment, a keyword category may include generic references to a product and/or service. In an embodiment, a keyword category may include branded references, such as search phrases including at least a portion of a trademark or trade name, to a product and/or service.

A maximum CPC may include the maximum cost per click for each keyword. In an embodiment, other price measures such as a minimum CPC, a maximum or minimum CPA, a maximum or minimum CPM or the like may additionally or alternately be included in a production sheet.

A keyword match type may include a method in which a keyword is matched. For example, if the match type on Yahoo! is set to “Standard,” only a query that exactly matches the keyword or search term may be recognized as a match. In contrast, if the match type is set to “Advanced,” a query that includes the keyword or search term may be recognized as a match. Google offers slightly different conventions, titling their standard match as “exact match”, advanced match as “broad match”, and provides a third option titled “phrase match” where the intended keyword must show up within the ultimate search query, with the intended terms queried in that sequence (but verbiage may fall before or after the intended clause). Additional or alternate match types may also be used within the scope of the disclosed embodiments.

Once the one or more production sheets are generated, the production sheets may be reviewed 230 for approval by an editorial panel or process prior to launching 232 the advertising campaign.

FIG. 2B depicts a flow chart for unstructured data extraction, synthesis and campaign creation according to an embodiment. As shown in FIG. 2B, if unstructured content is received, the content may be organized in order to extract the production assets and the various attributes for such assets. Organizing the content may assist in developing keywords and creatives.

In an embodiment, clustering 240 may be performed to provide structure to the unstructured content. Clustering may organize unstructured content that appears to be related based on the assets and attributes required for a production sheet. Content clustering may be performed by crawling unstructured content and creating order by recognizing and extracting concepts, clauses and multi-term keywords. Clustering may differ from other ordering techniques (classification, taxonomy building, tagging, etc.) by being fully automated.

Once unstructured content has been clustered, keywords or search phrases may be generated 242 using pre-developed syntactical taxonomies. In addition, landing pages may be selected 216 based on the identified marketing assets and attributes for each keyword or search phrase. The landing pages and/or keywords may be bundled together thematically using a cyclical process. Categories may be designated by grouping commonly themed keywords, landing pages directed to similar products and/or services or any combination thereof.

Attribute inferencing 244 may also be performed as part of the cyclical process to decipher context from an unstructured data feed. In an embodiment, attribute inferencing may include examining the proximity and frequency of particular words and/or word forms in the data feed in order to recognize and/or generate more specific keywords. In an embodiment, a creative having entry points for which particular attributes are assigned may be designed for a cluster. In an embodiment, content may be grouped based on a particular attribute, such as age since initial posting, to form a cluster.

After assets and attributes are assigned to a cluster, one or more keywords for a cluster may be transmitted to a media venue inventory forecast tool 222 in order to generate entry bids. In an alternate embodiment, a sensitivity analysis may be performed 248 from one or more client site categories or product lines in order to gauge the maximum viable CPC and match types for a particular keyword. In an embodiment, the match types and CPC values may be determined based on Return on Investment (ROI) goals 246 provided by a customer.

Creative templates may be applied and customized by category based on one or more data attributes and/or past campaign experience (as suggested by the keyword performance database 226).

As with structured content, one or more production sheets 228 may be generated based on the same campaign assets and attributes. Each production sheet may accommodate one or more media venues and/or sub-campaigns. In an embodiment, assets and selections may be qualified and/or refined using a database 226. Once the one or more production sheets are generated, the production sheets may be reviewed 230 for approval by an editorial panel or process prior to launching 232 the advertising campaign.

In an embodiment, an online publisher may desire to start a marketing campaign that lists current content or news items with a media venue. The publisher may have, for example, an XML feed containing its most recently published articles. The feed may be crawled to extract keywords that may be used to tap into such articles. A creative may be designed based on the content and the headlines and customized based on keyword insertion. Landing pages may be extracted directly from the feed. These assets may be organized into campaign silos on, for example, a per article basis.

The newness of such content may enable the advertiser to launch campaign assets with minimal entry bids, such as $0.05 or $0.10 per click depending on the media venue in question. Such an entry bid may be available because the content has been generated so recently that other advertisers cannot produce a marketing campaign of their own including the same content in a timely fashion. Ultimately this speed-to-market solution may assist in staving off bid inflation. Accordingly, the publisher may efficiently expend resources for its campaign. The above description is merely exemplary of a real-time marketing campaign using a disclosed embodiment. Alternative systems, methods, advertisers and campaigns will be readily apparent to those of skill in the art.

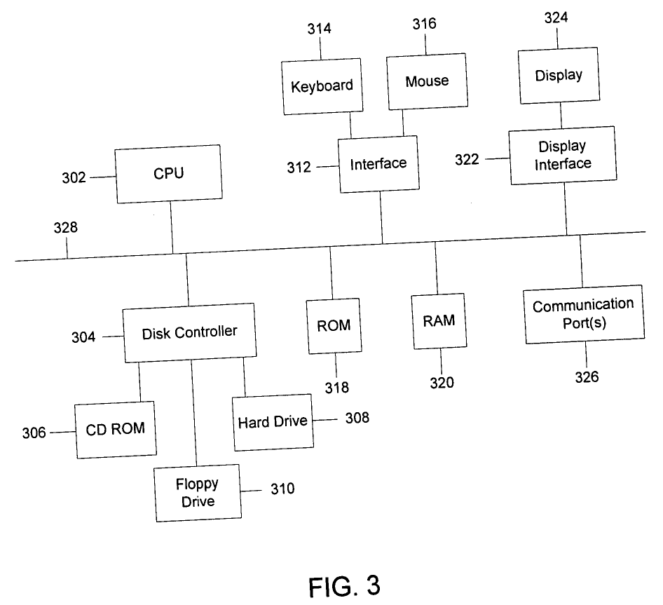

FIG. 3 is a block diagram of exemplary internal hardware that may be used to contain or implement program instructions according to an embodiment. Referring to FIG. 3, a bus 328 may serve as a main information highway interconnecting the other illustrated components of the hardware. CPU 302 is the central processing unit of the system, performing calculations and logic operations required to execute a program. Read only memory (ROM) 318 and random access memory (RAM) 320 constitute exemplary memory devices.

A disk controller 304 interfaces with one or more optional disk drives to the system bus 328. These disk drives may be external or internal floppy disk drives such as 310, CD ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports 326. An exemplary communication port 326 may be attached to a communications network, such as the Internet or an intranet.

In addition to computer-type components and their equivalents, the hardware may also include an interface 312 which allows for receipt of data from input devices such as a keyboard 314 or other input device 316 such as a remote control, pointer and/or joystick.

A multiprocessor system may optionally be used to perform one, some or all of the operations described herein. Likewise, an embedded system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for creating a production sheet for a media venue, the method comprising:
receiving content pertaining to one or more of a product and a service;
automatically generating one or more assets based on the content, wherein the assets comprise a keyword and a creative;
generating a production sheet comprising the keyword and the creative; and
submitting the production sheet to a media venue.

2. The method of claim 1, further comprising:
accessing pricing information from a database; and
determining a bid price for the keyword based on at least the pricing information,
wherein the production sheet further comprises the bid price.

3. The method of claim 2 wherein the pricing information comprises one or more of the following:
a query;
a maximum cost per click for the query;
a current cost per click for the query;
a click-through rate for the query;
a conversion rate for the query;
a query rate for the query;
a rank for a resultant listing; and
an average position for the resultant listing.

4. The method of claim 2 wherein the database is maintained by a content maintainer.

5. The method of claim 2 wherein the database is maintained by a media venue provider.

6. The method of claim 2 wherein determining the bid price comprises comparing the pricing information with budget information, wherein the budget information comprises one or more of the following:
a duration;
a total cost;
a desired number of views;
a desired number of click-throughs; and
a desired number of conversions.

7. The method of claim 2, further comprising:
qualifying the pricing information based on a pricing information database.

8. The method of claim 1 wherein receiving content comprises one or more of the following:
receiving a data feed from an advertiser;
retrieving data from a network location;
performing deep-Web extraction; and
extracting content from a Web site via a forms-based interface.

9. The method of claim 1 wherein the assets further comprise one or more of the following:
a keyword category;
a file locator for a landing page;
a transaction identifier;
a rule used to determine when to display the creative on the media venue;
a campaign title;
a product description;
an image;
a sound file; and
a video file.

10. The method of claim 1 wherein the production sheet further comprises one or more of the following:
a campaign name;
a budget;
a keyword category;
a keyword match type;
a file locator to be displayed with the creative;
a file locator for a landing page;
a tracking identifier; and
a hyperlink.

11. The method of claim 1 wherein the production sheet is organized based on rules promulgated by the media venue.

12. The method of claim 1 wherein the media venue comprises one or more of the following:
a search engine;
a directory listing Web site;
an Internet publication;
a network of Web sites;
a media player;
a WiFi network;
interactive television;
a print publication;
a classified listing;
a newspaper;
a public computer terminal;
a kiosk;
a direct mailing; and
a telephone directory.

13. The method of claim 1 wherein the creative comprises one or more of the following:
a search engine result listing;
a directory listing;
a banner advertisement;
a rich media advertisement;
a video advertisement;
a pop-up advertisement;
a pop-under advertisement; and
a print advertisement.

14. A system for creating a production sheet for a media venue, the system comprising:
a processor;
a processor-readable storage medium in communication with the processor;
a communication network in communication with the processor; and
a media venue server in communication with the communication network,
wherein the processor-readable storage medium contains one or more programming instructions for performing a method for creating a production sheet for a media venue, the method comprising:
receiving content pertaining to one or more of a product and a service,
automatically generating one or more assets based on the content, wherein the assets comprise a keyword and a creative,
generating a production sheet comprising the keyword and the creative, and
transmitting the production sheet to the media venue server via the communication network.

15. The system of claim 14 wherein the process-readable storage medium further comprises one or more programming instructions for performing the following:
accessing pricing information from a database; and
determining a bid price for the keyword based on the pricing information,
wherein the production sheet further comprises the bid price.

16. The system of claim 15 wherein determining the bid price comprises one or more programming instructions for comparing the price information with budget information, wherein the budget information comprises one or more of the following:
a duration;
a total cost;
a desired number of views;
a desired number of click-throughs; and
a desired number of conversions.

17. The system of claim 15, further comprising:
a pricing information storage medium,
wherein the process-readable storage medium further comprises one or more programming instructions for qualifying the pricing information based on data stored in the pricing information storage medium.

18. The system of claim 14, further comprising:
an advertiser server in communication with the communication network,
wherein receiving content comprises one or more programming instructions for receiving content from the advertiser server via the communication network.

19. The system of claim 14, further comprising:
an advertiser server in communication with the communication network,
wherein receiving content comprises one or more programming instructions for extracting content from a file located on the advertiser server.

20. The system of claim 14 wherein the assets further comprise one or more of the following:
a keyword category;
a file locator for a landing page;
a transaction identifier;
a rule used to determine when to display the creative on the media venue;
a campaign title;
a product description;
an image;
a sound file; and
a video file.

21. The system of claim 14 wherein the production sheet further comprises one or more of the following:
a campaign name;
a budget;
a keyword category;
a keyword match type;
a file locator to be displayed with the creative;
a file locator for a landing page;
a tracking identifier; and
a hyperlink.

22. The system of claim 14 wherein the production sheet is organized based on rules promulgated by the media venue server.

23. The system of claim 14 wherein the media venue server comprises one or more of the following:
a search engine;
a directory listing Web site;
an Internet publication;
a network of Web sites;
a media player;
a WiFi network;
interactive television;
a print publication;
a classified listing;
a newspaper;
a public computer terminal;
a kiosk;
a direct mailing; and
a telephone directory.

24. The system of claim 14 wherein the creative comprises one or more of the following:
a search engine result listing;
a directory listing;
a banner advertisement;
a rich media advertisement;
a video advertisement;
a pop-up advertisement;
a pop-under advertisement; and
a print advertisement.
